(19) United States
(12) Patent Application Publication
(10) Pub. No.: US 2008/0083462 A1
(43) Pub. Date: Apr. 10, 2008

(54) Method and apparatus for pressure regulation

(75) Inventors: Donald W. Smeller, Converse, TX (US); John R. Webb, Helotes, TX (US)

Correspondence Address: Dennis Braswell;Braswell & Associates, P.C., 105 Soost Court, Mobile, AL, 36608, US

(73) Assignee: Lancer Partnership, Ltd.

(21) Appl. No.: 11/545,195

(22) Filed: Oct. 10, 2006

(51) Int. Cl. G05D 16/06

(52) U.S. Cl. 137/505.42

(57) ABSTRACT

A pressure regulator is provided in which a valve (19) is coupled to a body (14), and is used to regulate gas pressure in a regulated pressure chamber (34). Valve (19) includes a movable sealing member (22) that is relatively soft. The movable sealing member (22) seals against a passageway (26) formed in a capsule body (20). The capsule body (20) is made of a material that is harder than the sealing member (22).

### TECHNICAL FIELD OF THE INVENTION

This invention relates generally to the regulation of pressure, and more particularly to methods and apparatus for regulating gas pressure.

### BACKGROUND OF THE INVENTION

Many applications call for gas pressures to be regulated. Generally speaking, in such applications, the gas is supplied from a relatively high pressure supply, such as from a pressure vessel, and regulated down to a lower pressure for actual use. For example, and without limitation, many fountain beverage systems include pressure regulators to achieve desired carbon dioxide gas pressures for use in making carbonated water and for driving syrup pumps. As another example, keg beer systems regulate carbon dioxide gas pressures to deliver beer to taps. Of course, many other applications exist for pressure regulation of gases, both inside and outside of the beverage industry.

While many pressure regulators exist and are reasonably reliable, there is a need to lower costs of the regulators, and to improve their performance and reliability. Indeed, one particular problem with existing regulators is their relatively high complexity, which results in relatively higher costs and complexity in manufacturing, assembly, and repair.

Therefore, a need has arisen for an improved pressure regulator and method of regulating pressure.

### SUMMARY OF THE INVENTION

In accordance with the teachings of the present invention, methods and apparatus for pumping and dispensing are provided which eliminate or substantially reduce the problems associated with prior art systems.

In one aspect of the present invention, a pressure regulator is provided that includes a regulator body having a gas inlet, a regulated pressure chamber coupled to a regulated pressure outlet, and a valve coupled between the gas inlet and the regulated pressure chamber. The valve includes a valve body having a passageway with a first end that opens to the regulated pressure chamber and a second end opposite the first end, the valve body being made of a first material. The valve also includes a movable sealing member comprising a second material softer than the first material, and a stem extending through the passageway and into the regulated pressure chamber, such that the movable sealing member seals the passageway at the second end when pressure in the regulated pressure chamber reaches a set pressure.

In other embodiments of the present invention, the movable sealing member is made of fluoroethylenepropylene or other plastics. Also, the stem may be coupled to the movable sealing member by pressing an attachment end of the stem into the movable sealing member.

In other embodiments of the present invention, the movable sealing member has a non-round shape, and may, in particular, have a hexagonal shape. In other embodiments of the present invention, the second end of the passageway may be chamfered.

In still other embodiments of the present invention, the pressure regulator may also include a first spring coupled to the movable sealing member and urging it toward sealing engagement with the passageway, a diaphragm, the diaphragm forming part of the regulated pressure chamber, and a second spring coupled to the diaphragm, the second spring urging the diaphragm toward the stem, such that the diaphragm pushes the stem to move the movable sealing member away from sealing engagement with the passageway when pressure in the regulated pressure chamber is below the set pressure.

In some embodiments, a safety relief valve may be coupled to the regulated pressure chamber.

In still other embodiments, the valve body includes threads for threaded engagement with the regulator body. Also, the valve may include a spring coupled to the movable sealing member and urging it toward sealing engagement with the passageway, and a stop against which the spring pushes opposite the movable sealing member, the stop being coupled to the valve body, such that the valve comprises an integrated unit. The valve body may also include a head shaped to accommodate a socket for screwing the valve body into the regulator body.

Also provided is a method of regulating pressure, that includes introducing a gas at a first pressure, and regulating the gas pressure and communicating the gas to a regulated pressure chamber by urging a movable sealing member comprised of a first material away from sealing engagement with a passageway formed in a body comprised of a second material harder than the first material when the pressure in the regulated pressure chamber is below a set pressure, and urging the movable sealing member toward sealing engagement with the passageway when the pressure in the regulated pressure chamber is above the set pressure.

Important technical advantages are provided herein, including, without limitation, the provision of a movable sealing member that is softer than the member against which it seals. In particular, the movable sealing member may be made of a plastic such as fluoroethylenepropylene, which seals well, does not require encapsulation, and has a low coefficient of friction. Another important technical advantage of the present invention is the provision of an integrated valve that can be readily coupled and removed from a regulator body, which reduces complexity and cost in assembly and repair.

### BRIEF DESCRIPTION OF THE DRAWINGS

Reference is made in the description to the following briefly described drawings, wherein like reference numerals refer to corresponding elements:

FIG. 1 is a sectional schematic illustration of one embodiment of a pressure regulator according to one aspect of the teachings of the present invention;

FIG. 2 is another sectional schematic illustration of the pressure regulator illustrated in FIG. 1;

FIG. 3 is a schematic illustration of a sealing mechanism according to one aspect of the teachings of the present invention;

FIG. 4 is an exploded diagram of the sealing mechanism shown in FIG. 3; and

FIG. 5 is a sectional schematic illustration of one embodiment of an externally adjusted pressure regulator bonnet assembly according to one aspect of the teachings of the present invention.

### DETAILED DESCRIPTION OF THE INVENTION

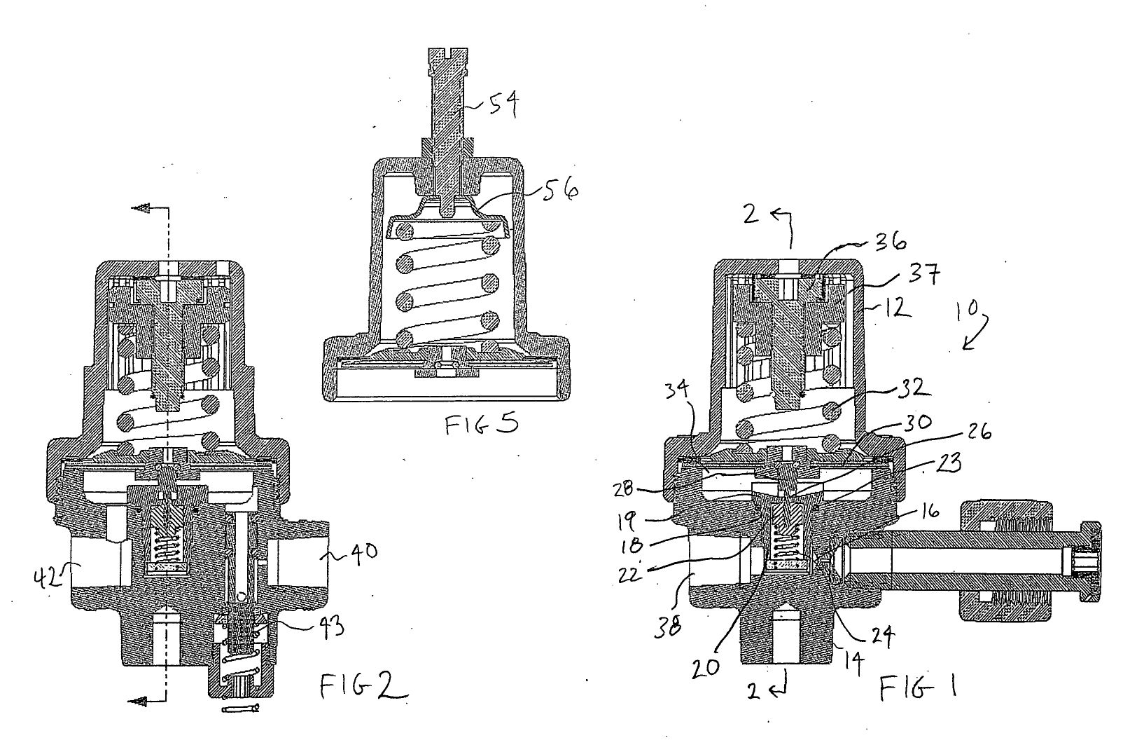

FIG. 1 is a sectional view of a pressure regulator 10 according to one aspect of the present invention. As shown in FIG. 1, a bonnet 12 is coupled to a regulator body 14, for example, and without limitation, by threaded engagement. An inlet 16 in the body 14 receives high pressure gas, which is communicated to a valve chamber 18. A valve 19 is positioned in the valve chamber 18, and includes a capsule body 20 (or valve body 20) coupled to body 14, for example, and without limitation, by threaded engagement. Capsule body 20 is preferably made of brass, but may be made of any suitable material. Capsule body 20 seals against an O-ring seal 23 to prevent high pressure gas from leaking from the valve chamber 18.

Capsule body 20 has a void 21 in which a sealing member 22 is positioned. The sealing member 22 is preferably made of a moldable grade of fluorinated ethylene propylene (“FEP”), but may be made of, without limitation, other fluorocarbon resins, other plastics or any other suitable material. As will be discussed below, one aspect of the present invention is that the sealing member 22, which is a moving part of the valve 19, is softer than the part against which it seals (in the example shown, it seals against the capsule body 20 to close an opening (or passageway) 26 in the capsule body 20). Sealing member 22 is coupled to a spring 24, which urges sealing member 22 toward the opening 26 to close the valve 19. A stem 28 protrudes from the sealing member 22 and through the opening 26 for interaction with a flexible diaphragm 30. “Stem” refers to any device or component suitable for performing the function of stem 28. A spring 32 is coupled to the flexible diaphragm 30 and urges it downward into contact with the stem 28 so that it pushes sealing member 22 away from opening 26 to open the valve. The space between the diaphragm 30 and the opening 26 is a regulated pressure chamber 34.

In operation, when the pressure in regulated pressure chamber 34 is low enough, the spring 32 is strong enough to overcome the force of spring 24 and push the diaphragm 30 and stem 28 so that sealing member 22 moves away from opening 26. This opening admits gas into the chamber 34, thus increasing pressure in the chamber 34, which in turn forces the diaphragm 30 upward against the spring 32. This eventually reduces the force on the stem 28 sufficiently to allow the spring 24 to push the sealing member 22 against the opening 26 to close the valve 19.

The loading on the diaphragm 30 may be increased or decreased by adjusting the force on the spring 32 at its end opposite of the diaphragm 30, thus changing the regulated pressure setting. The particular pressure regulator 10 illustrated in FIG. 1 is an internally adjusted regulator, wherein the spring 32 is adjusted by passing a tool, such as an allen wrench, through a passageway in the bonnet 12 to adjust a screw 36 coupled to a spring stop 37.

Also shown in FIG. 1 is a high pressure gauge port 38. FIG. 2 shows a sectional view taken along the “2” axis shown on FIG. 1. As shown in FIG. 2, regulated chamber 34 is coupled to regulated pressure outlet 40 and to regulated pressure gauge port 42. A safety relief valve 43, coupled to the regulated pressure chamber 34, may also be provided to safely vent gas in case of over-pressure in the regulated pressure chamber 34. The inlet, outlet, and ports shown throughout the FIGUREs may be threaded to accommodate coupling.

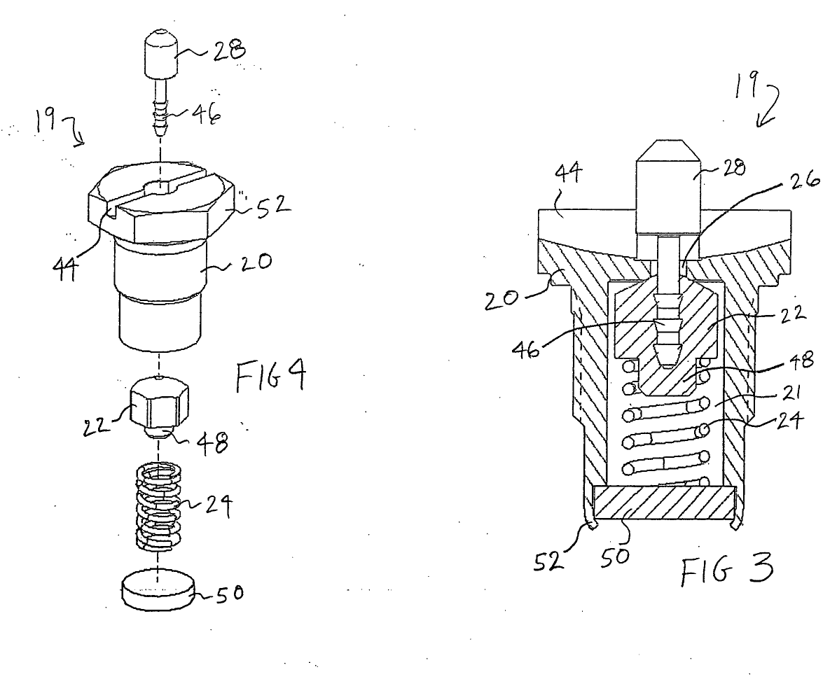

FIGS. 3 and 4 illustrate more detailed views of valve 19. As shown, the capsule body 20 may include a channel 44 to facilitate gas entry into the regulated pressure chamber 34. Stem 28, which may be made of any suitable material, for example, and without limitation, stainless steel or brass, is coupled to the sealing member 22, for example, and without limitation, by pressing an end of it into the sealing member 22. The end of stem 28 that is coupled to sealing member 22 may include barbs 46 (or any other suitable features) to facilitate adequate coupling.

The sealing member 22 may include a boss 48 or other structure to facilitate coupling with the spring 24. Spring 24 presses, at the end opposite sealing member 22, on a stop 50, which may be held by the capsule body 20 by swaging open-end 52. Of course, no such stop is needed, and the spring 24 may press against the body 14. Stop 50 may be a sintered brass filter, which has a high porosity, allowing gas to pass into the valve. Other approaches may also be used to allow gas to enter the valve, for example, and without limitation, by not closing the valve, or by providing one or more passageways through the valve body 20.

As shown in FIG. 4, sealing member 22 may have a generally hexagonal shape, with a conical top. However, any shape suitable for sealing may be used. In general, the sealing member 22 should be shaped to allow gas to flow around it and through the opening 26 when the valve 19 is open, and so that it remains properly oriented while opening and closing. When valve 19 closes, the top of sealing member 22 seals against the capsule body 20 to close the opening 26. As shown in FIG. 3, the end of opening 26 that opens into the void 21 may be chamfered to facilitate better sealing engagement with sealing member 22.

In prior art regulators, the moving part of the valve is made of a relatively hard material, such as brass or stainless steel, and sealed against a stationary soft piece which is generally encapsulated with a metal retainer. With the present invention, the moving part is the softer part. Also, therefore, with the present invention, no such encapsulation is necessary.

Furthermore, by forming the sealing member 22 with a material such as FEP, there is relatively little friction between the sealing member 22 and the inside of capsule body 20, in cases where they come into contact. This is in contrast to prior art systems where the moving piece and the sides of the void in which it travels are metal, and thus its movement can be hindered due to higher friction or scratching.

Furthermore, with the valve 19 discussed above, when formed as an integrated unit (such as, without limitation, by coupling the stop 50 to the valve body 20), assembly and repair of pressure regulators is greatly simplified. In particular, during assembly, the integrated valve 19 is simply coupled to the regulator body 14 (at the valve chamber 18), such as, without limitation, by screwing in using a socket. Thus, the valve body 20 and valve chamber 18 may be threaded. For a failed valve, the bonnet and diaphragm simply need to be removed from the regulator body, and the integrated valve unit is then removed and replaced with a new one. To facilitate easy removal and replacement, the valve body 20 may be formed with a head 52 that accommodates a socket.

FIG. 5 shows a sectional view of a bonnet, spring, and diaphragm assembly that allows for external adjustment of the spring force (and thus the pressure set point) by screwing a screw 54 coupled to a spring stop 56.

Within this description, coupling includes both direct coupling of elements, and coupling indirectly through intermediate elements.

The particular embodiments and descriptions provided herein are illustrative examples only, and features and advantages of each example may be interchanged with, or added to the features and advantages in the other embodiments and examples herein. Moreover, as examples, they are meant to be without limitation as to other possible embodiments, are not meant to limit the scope of the present invention to any particular described detail, and the scope of the invention is meant to be broader than any example. Also, the present invention has several aspects, as described above, and they may stand alone, or be combined with some or all of the other aspects.

And, in general, although the present invention has been described in detail, it should be understood that various changes, alterations, substitutions, additions and modifications can be made without departing from the intended scope of the invention, as defined in the following claims.

What is claimed is:

1. A pressure regulator, comprising:
a regulator body having a gas inlet;
a regulated pressure chamber coupled to a regulated pressure outlet; and
a valve coupled between the gas inlet and the regulated pressure chamber, the valve comprising:
a valve body having a passageway with a first end that opens to the regulated pressure chamber and a second end opposite the first end, the valve body being made of a first material;
a movable sealing member comprising a second material softer than the first material; and
a stem extending through the passageway and into the regulated pressure chamber;
such that the movable sealing member seals the passageway at the second end when pressure in the regulated pressure chamber reaches a set pressure.

2. The pressure regulator of claim 1, wherein the movable sealing member is comprised of fluorinated ethylene propylene.

3. The pressure regulator of claim 1, wherein the movable sealing member is comprised of a plastic.

4. The pressure regulator of claim 3, wherein the stem has an attachment end coupled to the movable sealing member by pressing the stem into the movable sealing member.

5. The pressure regulator of claim 1, wherein the movable sealing member has a non-round shape.

6. The pressure regulator of claim 1, wherein the movable sealing member has a hexagonal shape.

7. The pressure regulator of claim 1, wherein the second end of the passageway is chamfered.

8. The pressure regulator of claim 1, and further comprising:
a first spring coupled to the movable sealing member and urging it toward sealing engagement with the passageway;
a diaphragm, the diaphragm forming part of the regulated pressure chamber; and
a second spring coupled to the diaphragm, the second spring urging the diaphragm toward the stem;
such that the diaphragm pushes the stem to move the movable sealing member away from sealing engagement with the passageway when pressure in the regulated pressure chamber is below the set pressure.

9. The pressure regulator of claim 1, and further comprising a safety relief valve coupled to the regulated pressure chamber.

10. The pressure regulator of claim 1, and wherein the valve body comprises threads for threading engagement with the regulator body.

11. The pressure regulator of claim 1, wherein the valve further comprises:
a spring coupled to the movable sealing member and urging it toward sealing engagement with the passageway; and
a stop against which the spring pushes opposite the movable sealing member, the stop being coupled to the valve body, such that the valve comprises an integrated unit.

12. The pressure regulator of claim 11, and wherein the valve body comprises threads for threading engagement with the regulator body.

13. The pressure regulator of claim 12, wherein the valve body further comprises a head shaped to accommodate a socket for screwing the valve body into the regulator body.

14. A method of regulating pressure, comprising:
introducing a gas at a first pressure; and
regulating the gas pressure and communicating the gas to a regulated pressure chamber by:
urging a movable sealing member comprised of a first material away from sealing engagement with a passageway formed in a body comprised of a second material harder than the first material when the pressure in the regulated pressure chamber is below a set pressure; and
urging the movable sealing member toward sealing engagement with the passageway when the pressure in the regulated pressure chamber is above the set pressure.
